(19) United States
(12) Patent Application Publication
(10) Pub. No.: US 2019/0218809 A1
(43) Pub. Date: Jul. 18, 2019

(54) Special compact motorcycle storage compartment and structural device

(71) Applicants: Will Pearson, Indianapolis, IN (US); James Rutan, Indianapolis, IN (US); Ed Kello, Fishers, IN (US)

(72) Inventors: Will Pearson, Indianapolis, IN (US); James Rutan, Indianapolis, IN (US); Ed Kello, Fishers, IN (US)

(21) Appl. No.: 15/959,483

(22) Filed: Apr. 23, 2018

Related U.S. Application Data
(63) Continuation of application No. 62/617,472, filed on Jan. 15, 2018.

(51) Int. Cl. E04H 6/00; B62H 3/04; B65D 85/68

(52) U.S. Cl. CPC E04H 6/005; B65D 2585/6865; B65D 85/68; B62H 3/04

(57) ABSTRACT

A special compact motorcycle storage compartment for use in various applications. It consists of an exterior structure and lockable door. When a motorcycle is inside, the enclosure prevents vandalism and theft. The structure is not large enough to accommodate a person with the motorcycle. To move a motorcycle into the structure, the combination of a track system and wheel chock is used to keep the motorcycle in an upright position while moving it directly in and out of the structure. An extended handle and the wheel chock is mounted to a supporting platform. The platform is attached to two tracks which allows for movement of the platform in only two directions. The motorcyclist can push or pull on the handle to move the motorcycle into or out of the structure. Once the motorcycle is inside, the front door may be closed and locked, thus securing the motorcycle.

### CROSS-REFERENCE TO RELATED APPLICATIONS

This application claims the benefit of U.S. Provisional Patent Application with Ser. No. 62/617,472 filed Jan. 25, 2018, by Will Pearson, James Rutan, and Ed Kello and entitled “SafeBay Motorcycle Storage” device.

### FIELD OF INVENTION

This invention relates to a Special compact motorcycle storage compartment and structural device. The present invention relates to the storage of motorcycles. The present invention relates to the field of security shelters for small personal transportation vehicles. This relates to garages for recreational vehicles, bicycles, and four-wheelers and more particularly involves an enclosure designed to house a motorcycle. The present invention relates generally to enclosures for small personal vehicles and, more particularly, to such enclosures which are compact, of simplified construction, and readily assembled.

### FEDERALLY SPONSORED RESEARCH

None.

### SEQUENCE LISTING OR PROGRAM

None.

### BACKGROUND—FIELD OF INVENTION AND PRIOR ART

As far as is known, there are no Special compact motorcycle storage compartment and structural device or the like. It is believed that this product is unique in its design and technologies.

### Background

This background as to small storage for motorcycles and small vehicles is useful. Owners of valuable motorcycles are often confronted with the problem of garaging the same in a safe and convenient manner, especially when the owner lives in a mobile home court, apartment or the like where storage space is limited. When compelled to leave the vehicle out of doors the owner frequently employs a detachable cover, or houses the vehicle in a collapsible structure. However, these methods have disadvantages in that moisture can collect under the cover, or in the box; attaching and detaching of the cover, and storage of the same when not in use, are laborious; and in some situations the vehicle itself must be provided with modifications as by removal of its handlebars or windshield in order to fit it snugly within the enclosure. Moreover, such devices provide no significant protection against theft since the enclosure containing the vehicle is not firmly secured against removal as a unit.

Storage of motorcycles, riding lawn mowers, golf carts, and other small vehicles are seasonally used so that storage in a garage is often inconvenient as the stored vehicles get in the way of cars, etc. and are prone to being bumped or damaged. Many owners turn to commercial sheds and other large permanent structures to house their smaller seasonal vehicles, however this option is expensive and only possible on larger properties. Renters and people living in urban areas often do not even have a garage, and are forced to park their motorcycles on the side of the road where they are then subject to the elements, theft, damage, etc. or pay fees to store their motorcycles in commercial storage units, often located in inconvenient locations. Likewise, motorcycles and small ridden devices are lighter weight and are more easily stolen than their passenger car cousins. In attempts to avoid theft, owners often look for a fixed immovable object that they might be able to chain or cable the vehicle to so that it can avoid being completely carried away. However, such securable stations are often few and far between and, even if one is found, the bike though locally secured, will remain otherwise open to pilfering of its contents. It is not uncommon for the personal transportation vehicle owner to return to her vehicle only to find tires missing or storage pockets pillaged.

A closely related problem concerns the exposure to the elements. While passenger cars have sealed cabins protected by roofs and windows, personal transportation vehicles are most often devoid of such protection and are, thus, left exposed even while in temporary storage. Rain, wind, and snow can take their toll on sensitive portions of these vehicles. Many motorcycle and bicycle owners face finding suitable storage for their vehicle that provides adequate protection from the elements. Specifically designed vehicle covers made of cloth or plastic material are available but do not fully enclose a vehicle and offer inadequate protection. Debris and moisture that enter through gaps at anchor and tie points may damage a vehicle. Additionally, material in covers readily cracks or rots in a short time and subsequently exposes a vehicle to adverse elements.

Many prior art storage enclosures are bulky and therefore, inappropriate for use in a limited space. Most designs are to accommodate vehicles of various sizes, for example, a motorcycle, snowmobile, Jet Ski, and ATV. Consequently, their use requires a large area. For use at apartment and condominium complexes, it is often restricted to construct such bulky and unattractive storage devices. Basically, they are impractical.

### Problem Solved

The improvement and problem solved is to provide public and/or personal compact storage for a motorcycle or other small vehicle or goods that is easy to install and secure, prevents exposure to weather, and is made of durable materials and available component parts. What is needed is a storage container that is sufficiently sized to securely hold a motorcycle or other small vehicle, yet be lightweight and economical, easy to open and close for convenient storage and removal of the stored vehicle, and adapted to be permanently or temporarily installed on a flat surface such as a parking lot of flat ground.

### Prior Art

A novelty search of existing patents, applications and publications show there are no devices that uniquely address the problem and solve it the manner that the present invention resolves the need or problem. The prior art found includes: U.S. Pat. No. 3,861,092 issued in 1975 to Dale, et al. for a molded storage housing for a motorcycle; U.S. Pat. No. 5,369,920 issued in 1994 to Taylor for a motorcycle garage; U.S. Pat. No. 5,507,121 issued in 1996 to Taylor for another motorcycle garage; U.S. Pat. No. 6,012,253 issued to Burns in 2000 for a portable enclosure for small vehicles; U.S. Pat. No. 6,301,839 issued to Chapman in 2001 for a sled shed; U.S. Pat. 6,349,732 issued to Cooper in 2002 for a collapsible small vehicle enclosure; U.S. Pat. No. 6,718,697 issued to Voorhees in 2004 for a sponsored small vehicle storage device; U.S. Pat. No. 7,966,774 issued to Kea, Jr. et al. for a security shelter for small personal transportation vehicles; U.S. Pat. No. 9,890,549 issued to Gambarotta, et al. in 2018 for a storage system; and a US Patent Application 2014/0110287 by Hayden for a moveable storage container for storing vehicles. All these and others fall sorely short of anticipating or rendering obvious the present invention.

### SUMMARY OF THE INVENTION

This invention is a Special compact motorcycle storage compartment and structural device for use in various applications. The invention described consists of an exterior structure with a lockable door. When a motorcycle is inside the system, the exterior and door will prevent vandalism and theft of the motorcycle. The structure is not intended to be large enough to accommodate a person entering with the motorcycle. To enable a person to move a motorcycle into the structure, the combination of a track system and wheel chock will be used to keep the motorcycle in an upright position while moving it directly in and out of the structure. The wheel chock will be mounted to a supporting platform. The supporting platform will be attached to two tracks in such a way as to allow for movement of the platform in only two directions. The tracks will be mounted to the base frame of the structure. The premise of the invention is that a motorcycle will be positioned on the wheel chock near the open front door. The wheel chock will support the front wheel and secure the motorcycle in an upright position. The motorcyclist will then push on an optional handle to move the motorcycle into the structure. The handle is attached to the platform supporting the wheel chock, and the platform is attached to the tracks and may move in or out of the container. Once the motorcycle has been moved into the structure through the use of the handle, the front door may be closed and locked, thus securing the motorcycle in the structure.

The preferred embodiment of a Special compact motorcycle storage compartment and structural device is comprised of: (a) an enclosure with an optional floor/base frame and a lockable front door; (b) a movable platform or panel for loading a motorcycle or small vehicle into the enclosure; (c) a means for securing the enclosure to the ground or pavement; and (d) a means to secure the movable platform to the optional floor/base frame of the enclosure or to the ground/pavement wherein the enclosure can hold a motorcycle inside the enclosure to prevent theft, vandalism, and exposure to weather. An expanded description is a special compact motorcycle storage compartment and structural device comprised of (a) an enclosure with an optional floor, a lockable front door (lock can be Bluetooth and other lock configurations to be linked with a mobile smartphone application and lock configurations interface with application for Point of Sale/Rental/authorization by owner of structure); a top panel, an end panel opposite the lockable door, a pair of side panels, wherein all of the said panels are made of a durable material and all of the said panels have edges around their respective perimeters, and a means for securing the edges of the panels to form the enclosure; (b) a movable platform or panel for loading a motorcycle or small vehicle into the enclosure, the movable panel further comprised of a track system, a chock assembly, and an optional handle assembly; (c) a means for securing the enclosure to the ground or pavement; and (d) a means to secure the movable platform to the optional floor/base frame of the enclosure wherein the enclosure can hold a motorcycle inside the enclosure to prevent theft, vandalism, and exposure to weather.

The newly invented Special compact motorcycle storage compartment and structural device can be manufactured at low volumes by very simple means and in high volume production by more complex and controlled systems.

### OBJECTS AND ADVANTAGES

There are several objects and advantages of the Special compact motorcycle storage compartment and structural device. There are currently no known motorcycle or small vehicle storage devices that are effective at providing the objects of this invention. The device has various advantages and benefits:

| Item | Advantages |
|---|---|
| 1 | prevents vandalism and theft of the motorcycle |
| 2 | uses a combination of parts already produced |
| 3 | is a universally designed track and chock for |
| | attachments to fit different motorcycles, All |
| | Terrain Vehicles (3 and 4-wheelers), jet skis, |
| | trike motorcycles, can-am style motorcycles, snow |
| | mobiles, bicycles, and small mini cars |
| 4 | is customizable for other vehicles or easy storage |
| | of sizeable goods (furniture, appliances, power |
| | tools, etc.); |
| 5 | keeps the motorcycle in an upright position |
| 6 | has a compact footprint and square footage for use |
| | in small parking lots and between houses or |
| | apartments |
| 7 | keeps vehicles safe and out of reach to children |
| | and pets |
| 8 | protects the motorcycle and vehicle from the |
| | weather - snow, rain, acid rains, sunshine, heat, |
| | and wind |
| 9 | can be manually or automatically operated |
| 10 | can have supplemental ventilation |
| 11 | can have Bluetooth and other lock configurations |
| | to be linked with a mobile smartphone application |
| 12 | can have lock configurations interface with |
| | application for Point of Sale/ Rental/ |
| | authorization by owner of structure |

Finally, other advantages and additional features of the present Special compact motorcycle storage compartment and structural device will be more apparent from the accompanying drawings and from the full description of the device. For one skilled in the art of storage compartment and structural devices, it is readily understood that the features shown in the examples with this product are readily adapted to other types of storage devices for small vehicles and the like.

### DESCRIPTION OF THE DRAWINGS—FIGURES

The accompanying drawings, which are incorporated in and constitute a part of this specification, illustrate an embodiment of the Special compact motorcycle storage compartment and structure. The drawings together with the summary description given above and a detailed description given below serve to explain the principles of the Special motorcycle storage device. It is understood, however, that the described and shown invention and special device is not limited to only the precise arrangements and instrumentalities shown.

FIGS. 1A through 1C are views of the Special compact motorcycle storage compartment and structural device from various views.

FIG. 2 is a front perspective view of the Special compact motorcycle storage compartment and structural device with components and features depicted.

FIG. 3 is a cross section view of the front perspective view of the structural storage device with the side of the exterior structure and the front door removed to provide for viewing the internal components and features. T

FIG. 4 is a front perspective cross sectional view with the side of the exterior structure and front door removed.

FIG. 5 is a front perspective view of the Special compact motorcycle storage compartment and structural device with features and components shown.

FIG. 6 is a sketch showing a powered and automated loading system and ventilation options for the Special compact motorcycle storage compartment and structural device with components shown.

FIGS. 7A and 7B are cross sectional side views showing the operation view of the motorcycle just loaded and then pushed into the storage structure and ready to be stored.

FIG. 8A through 8D are sketches of prior art of small storage compartments.

### DESCRIPTION OF THE DRAWINGS—REFERENCE NUMERALS

The following list refers to the drawings:

| Ref # | Description |
|---|---|
| 30 | special compact motorcycle storage compartment |
| | and structural device 30 |
| 30P | perspective view 30P of the special compact |
| | motorcycle storage compartment and structural |
| | device 30 |
| 30S | side view 30S of the special compact motorcycle |
| | storage compartment and structural device 30 |
| 30CS | cross section view 30CS of the special compact |
| | motorcycle storage compartment and structural |
| | device 30 |
| 35 | top 35 of the special compact motorcycle storage |
| | compartment and structural device 30 |
| 36 | end or rear panel 36 of the special compact |
| | motorcycle storage compartment and structural |
| | device 30 |
| 37 | pair of side panels 37 of the special compact |
| | motorcycle storage compartment and structural |
| | device 30 |
| 38 | a means 38 for connecting the panels 35, 36, 37, |
| | 40, 64 of the compartment 30 such as threaded |
| | fasteners, rivets, welding, bent metal tabs, |
| | adhesives and the like |
| 40 | lockable front door 40 |
| 41 | means 41 for securing the storage compartment |
| | floor 64 to the ground or pavement, such as |
| | threaded anchors, tap-cons, barbed stakes and the |
| | like |
| 42 | motorcycle 42 or other small vehicles such as |
| | All-Terrain Vehicles (3 and 4-wheelers), jet |
| | skis, trike motorcycles, reverse trike style |
| | motorcycles, snow mobiles, bicycles, and small |
| | mini cars |
| 50 | wheel chock assembly 50 |
| 51 | handle assembly 51 (optional) for platform 56 |
| 51A | means 51A for securing handle components 52 |
| | together to form a rigid handle assembly 51 |
| 52 | vertical, horizontal, and angled, structure |
| | components 52 |
| 52A | handle bracket 52A connecting handle components |
| | 52 to platform 56 |
| 53 | handle grip component 53 |
| 54 | front chock wheel stop 54 of chock assembly 50 |
| 55 | rear chock wheel hold component 55 of chock |
| | assembly 50 |
| 56 | movable platform or panel 56 for loading a |
| | motorcycle 42 or equal into the special compact |
| | motorcycle storage compartment and structural |
| | device 30 |
| 57 | track wheels 57 |
| 58 | track rails 58 |
| 59 | means 59 for securing track wheels 57 to platform |
| | assembly 56 |
| 60 | horizontal wheel channel 60 that extends between |
| | front wheel stop 54 and rear chock wheel hold |
| | component 55 of chock assembly 50 |
| 62 | means 62 for securing chock components 54, 55, 60 |
| | into a chock assembly 50 such as welding, |
| | threaded fasteners, rivets, cotter keys and pins, |
| | or integrally casting or molding |
| 63 | means 63 for removably securing chock assembly 50 |
| | to movable platform 56 such as pins, threaded |
| | fasteners, clips, etc. |
| 64 | floor/ base frame (optional) 64 of the special |
| | compact motorcycle storage compartment and |
| | structural device 30 |
| 65 | means 65 for securing track to floor 64 |
| 66 | entry ramp 66 |
| 68 | lock 68 - Bluetooth and other lock configurations |
| | to be linked with a mobile smartphone application |
| | and lock configurations interface with |
| | application for Point of Sale/ Rental/ |
| | authorization by owner of structure |
| 70 | prior Art 70 U.S. Pat. No. 3,861,092 by Dale - a molded |
| | storage housing for a motorcycle |
| 71 | prior Art 71 Patent Application 2014/0110287 by |
| | Hayden - a moveable storage container for storing |
| | vehicles |
| 72 | prior Art 72 U.S. Pat. No. 7,966,774 by Kea, Jr. et al. - |
| | a security shelter for small personal |
| | transportation vehicles |
| 73 | prior Art 73 U.S. Pat. No. 5,507,121 by Taylor - |
| | Motorcycle Garage |
| 80 | optional automatic drive system 80 with a |
| | mechanical drive system (chain, gear, sprocket, |
| | belt and pulleys, etc.) driven wheels 81, motor |
| | 82 |
| 81 | mechanically driven 81 and powered wheels |
| 82 | motor 82 for powered track |
| 83 | ventilation 83 louvers and optional powered |
| | ventilation system |
| 84 | trickle charge 84 and optional electric charge |
| | station for future electric charging station for |
| | electric motorcycles and small vehicles |
| 86 | power source 86 for track motor 82 or trickle |
| | charge 84 |

### DETAILED DESCRIPTION OF PREFERRED EMBODIMENT

The present invention relates to a Special compact motorcycle storage compartment and structural device. The present invention relates to the storage of motorcycles. The present invention relates to the field of security shelters for small personal transportation vehicles. This relates to garages for recreational vehicles, bicycles, and four-wheelers and more particularly involves an enclosure designed to house a motorcycle. The present invention relates generally to enclosures for small personal vehicles and, more particularly, to such enclosures which are compact, of simplified construction, and readily assembled.

The advantages for the Special compact motorcycle storage compartment and structural device 30 are listed above in the introduction. Succinctly the benefits are that the device:
A. prevents vandalism and theft of the motorcycle;
B. uses a combination of parts already produced;
C. is a universally designed track and chock for attachments to fit different motorcycles, All Terrain Vehicles (3 and 4-wheelers), jet skis, trike motorcycles, can-am style motorcycles, snow mobiles, bicycles, and small mini cars;
D. is customizable for other vehicles or easy storage of sizeable goods (furniture, appliances, power tools, etc.);
E. keeps the motorcycle in an upright position;
F. has a compact footprint and square footage for use in small parking lots and between houses or apartments;
G. keeps vehicles safe and out of reach to children and pets;
H. protects the motorcycle and vehicle from the weather—snow, rain, acid rains, sunshine, heat, and wind;
I. can be manually or automatically operated;
J. can have supplemental ventilation;
K. can have a Bluetooth and other lock configurations to be linked with a mobile smartphone application; and
L. can have lock configurations interface with application for Point of Sale/Rental/authorization by owner of structure

The preferred embodiment of a Special compact motorcycle storage compartment and structural device is comprised of: (a) an enclosure with a floor/base frame (optional) 64 and a lockable front door; (b) a movable platform or panel for loading a motorcycle or small vehicle into the enclosure; (c) a means for securing the enclosure to the ground or pavement; and (d) a means to secure the movable platform to the floor of the enclosure wherein the enclosure can hold a motorcycle inside the enclosure to prevent theft, vandalism, and exposure to weather. An expanded description is a special compact motorcycle storage compartment and structural device 30 comprised of (a) an enclosure with a floor/base frame (optional) 64, a lockable front door 40; a top panel, an end panel opposite the lockable door, a pair of side panels, wherein all of the said panels are made of a durable material and all of the said panels have edges around their respective perimeters, and a means for securing the edges of the panels to form the enclosure; (b) a movable platform or panel for loading a motorcycle or small vehicle into the enclosure, the movable panel further comprised of a track system, a chock assembly, and an optional handle assembly; (c) a means for securing the enclosure to the ground or pavement; and (d) a means to secure the movable platform to the floor of the enclosure wherein the enclosure can hold a motorcycle inside the enclosure to prevent theft, vandalism, and exposure to weather.

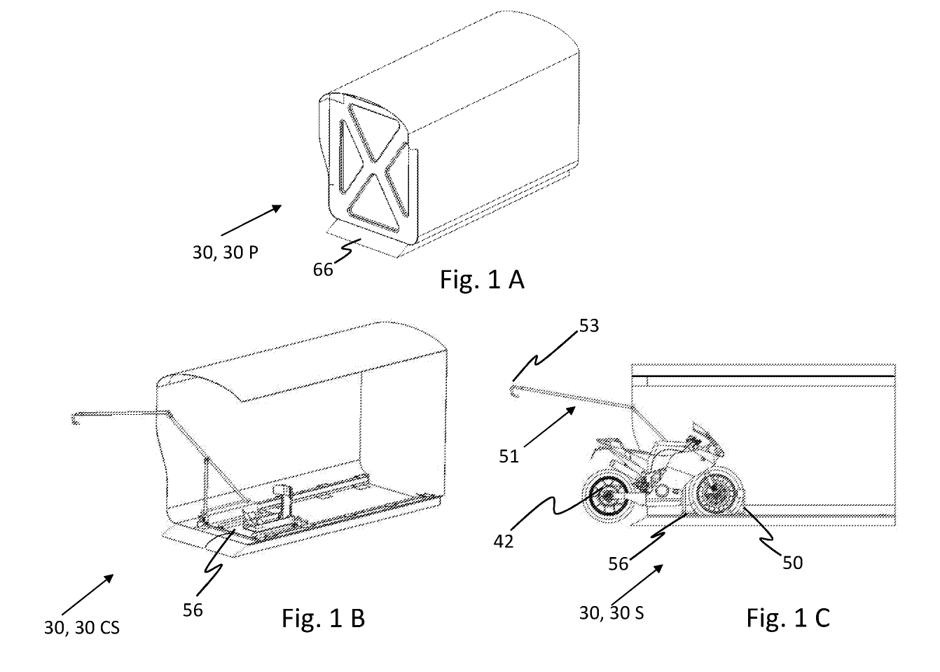

There is shown in FIGS. 1-8 a complete description and operative embodiment of the Special compact motorcycle storage compartment and structural device. In the drawings and illustrations, one notes well that the FIGS. 1-8 demonstrate the general configuration and use of this product. The various example uses are provided in the operation and use section, below.

The accompanying drawings, which are incorporated in and constitute a part of this specification, illustrate an embodiment of the Special compact motorcycle storage compartment and structural device 30 that is preferred. The drawings together with the summary description given above and a detailed description given below serve to explain the principles of the Special device 30. It is understood, however, that the Special compact motorcycle storage compartment and structural device 30 is not limited to only the precise arrangements and instrumentalities shown. Other examples of small vehicle storage compartments and the like are still understood by one skilled in the art of small storage structures to be within the scope and spirit shown here.

FIGS. 1A through 1C are views of the Special compact motorcycle storage compartment and structural device from various views. These sketches show: a special compact motorcycle storage compartment and structural device 30; a perspective view 30P of the special compact motorcycle storage compartment and structural device 30; a side view 30S of the special compact motorcycle storage compartment and structural device 30; a cross section view 3005 of the special compact motorcycle storage compartment and structural device 30; a motorcycle 42 or other small vehicles such as All-Terrain Vehicles (3 and 4-wheelers), jet skis, trike motorcycles, reversible trike style motorcycles, snow mobiles, bicycles, and small mini cars; a wheel chock assembly 50; an optional handle assembly 51 for platform 56; a movable platform or panel 56 for loading a motorcycle 42 or equal into the special compact motorcycle storage compartment and structural device 30; and an entry ramp 66.

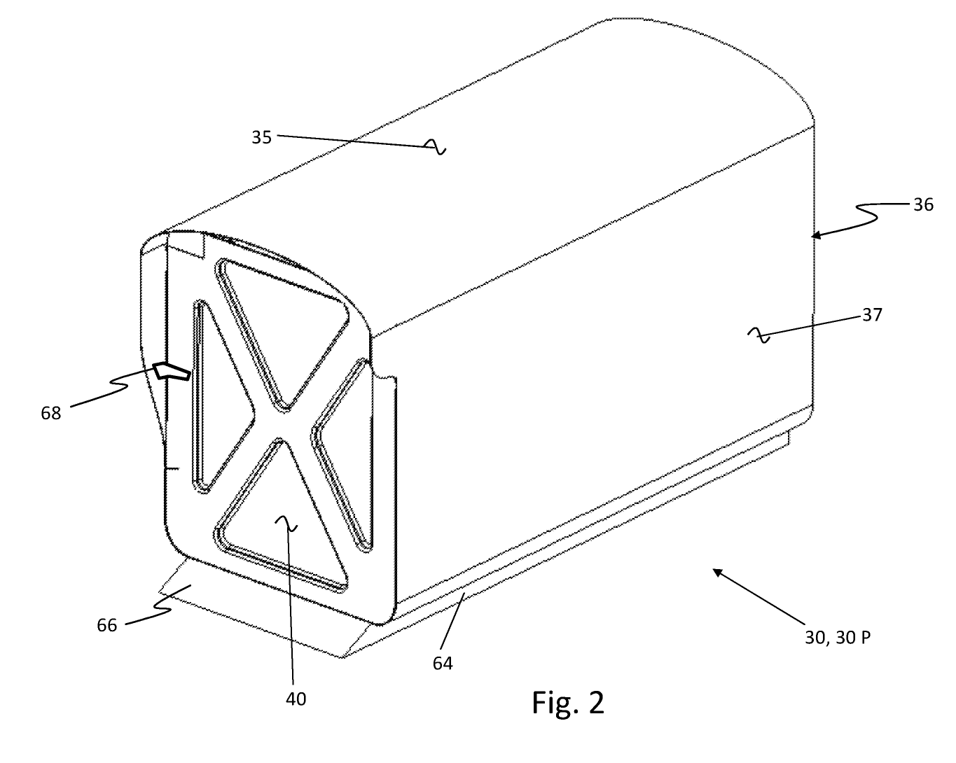

FIG. 2 is a front perspective view of the Special compact motorcycle storage compartment and structural device with components and features depicted. Demonstrated in these views are: a special compact motorcycle storage compartment and structural device 30; a perspective view 30P of the special compact motorcycle storage compartment and structural device 30; a top 35 of the special compact motorcycle storage compartment and structural device 30; an end or rear panel 36 of the special compact motorcycle storage compartment and structural device 30; a pair of side panels 37 of the special compact motorcycle storage compartment and structural device 30; a means 38 for connecting the panels 35, 36, 37, 40, 64 of the compartment 30 such as threaded fasteners, rivets, welding, bent metal tabs, adhesives and the like; a lockable front door 40; a means 41 for securing the storage compartment floor/base frame (optional) 64 to the ground or pavement, such as threaded anchors, tap-cons, barbed stakes and the like; a floor/base frame (optional) 64 of the special compact motorcycle storage compartment and structural device 30; an entry ramp 66; and a lock 68—Bluetooth and other lock configurations to be linked with a mobile smartphone application and lock configurations interface with application for Point of Sale/Rental/authorization by owner of structure.

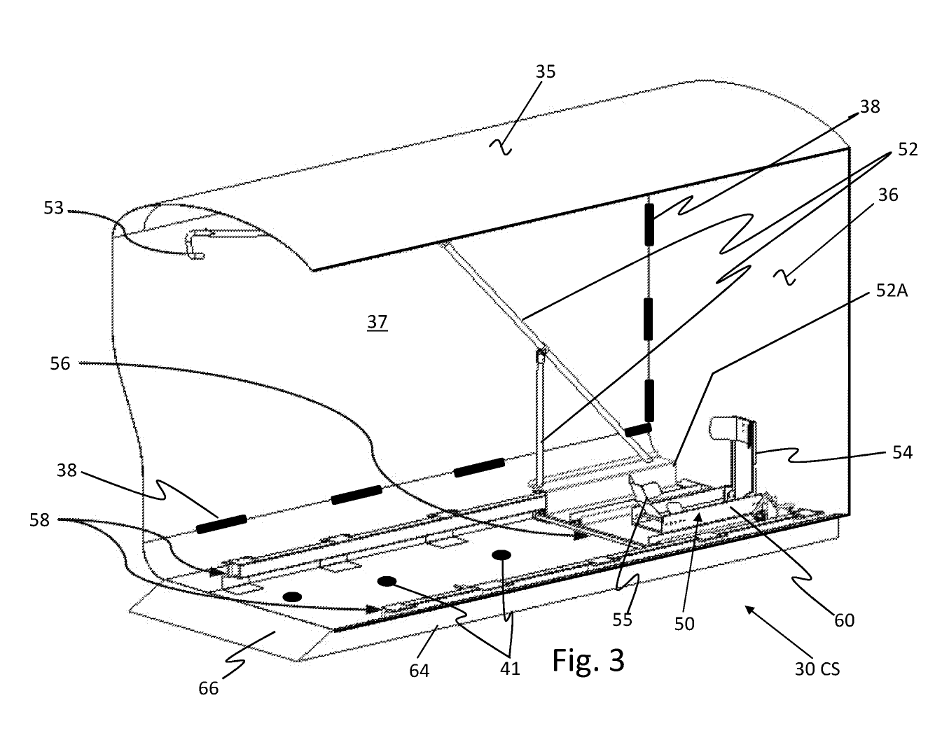

FIG. 3 is a cross section view of the front perspective view of the structural storage device with the side of the exterior structure and the front door removed to provide for viewing the internal components and features. The sketches here show: a special compact motorcycle storage compartment and structural device 30; a cross section view 3005 of the special compact motorcycle storage compartment and structural device 30; a top 35 of the special compact motorcycle storage compartment and structural device 30; an end or rear panel 36 of the special compact motorcycle storage compartment and structural device 30; a pair of side panels 37 of the special compact motorcycle storage compartment and structural device 30; a means 38 for connecting the panels 35, 36, 37, 40, 64 of the compartment 30 such as threaded fasteners, rivets, welding, bent metal tabs, adhesives and the like; a lockable front door 40; a means 41 for securing the storage compartment floor/base frame (optional) 64 to the ground or pavement, such as threaded anchors, tap-cons, barbed stakes and the like; an optional handle 51, the vertical, horizontal, and angled, structure components 52; a handle bracket 52A connecting handle components 52 to platform 56; a wheel chock assembly 50; a handle grip component 53; a front chock wheel stop 54 of chock assembly 50; a rear chock wheel hold component 55 of chock assembly 50; a movable platform or panel 56 for loading a motorcycle 42 or equal into the special compact motorcycle storage compartment and structural device 30; a pair of track rails 58; a means 59 for securing track wheels 57 to platform assembly 56; a horizontal wheel channel 60 that extends between front wheel stop 54 and rear chock wheel hold component 55 of chock assembly 50; a floor/base frame 64 of the special compact motorcycle storage compartment and structural device 30; a means 65 for securing track to floor/base frame (optional) 64 or ground/pavement; and an entry ramp 66.

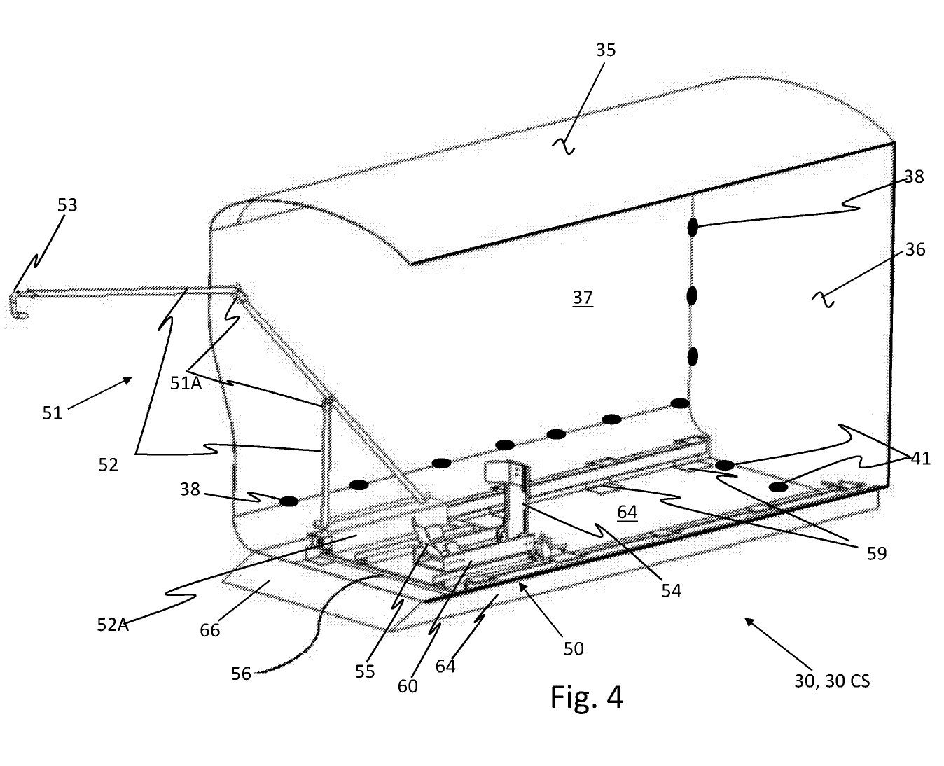

FIG. 4 is a front perspective cross sectional view with the side of the exterior structure and front door removed. Here the components portrayed include: a special compact motorcycle storage compartment and structural device 30; a cross section view 3005 of the special compact motorcycle storage compartment and structural device 30; a top 35 of the special compact motorcycle storage compartment and structural device 30; an end or rear panel 36 of the special compact motorcycle storage compartment and structural device 30; a pair of side panels 37 of the special compact motorcycle storage compartment and structural device 30; a means 38 for connecting the panels 35, 36, 37, 40, 64 of the compartment 30 such as threaded fasteners, rivets, welding, bent metal tabs, adhesives and the like; a lockable front door 40; a means 41 for securing the storage compartment floor/base frame (optional) 64 to the ground or pavement, such as threaded anchors, tap-cons, barbed stakes and the like; a set of track wheels 57; an optional handle 51, vertical, horizontal, and angled, structure components 52; a handle bracket 52A connecting handle components 52 to platform 56; a wheel chock assembly 50; a handle grip component 53; a front chock wheel stop 54 of chock assembly 50; a rear chock wheel hold component 55 of chock assembly 50; a movable platform or panel 56 for loading a motorcycle 42 or equal into the special compact motorcycle storage compartment and structural device 30; a pair of track rails 58; a means 59 for securing track wheels 57 to platform assembly 56; a horizontal wheel channel 60 that extends between front wheel stop 54 and rear chock wheel hold component 55 of chock assembly 50; a floor/base frame (optional) 64 of the special compact motorcycle storage compartment and structural device 30; a means 65 for securing track to floor/base frame (optional) 64 or ground/pavement; and an entry ramp 66.

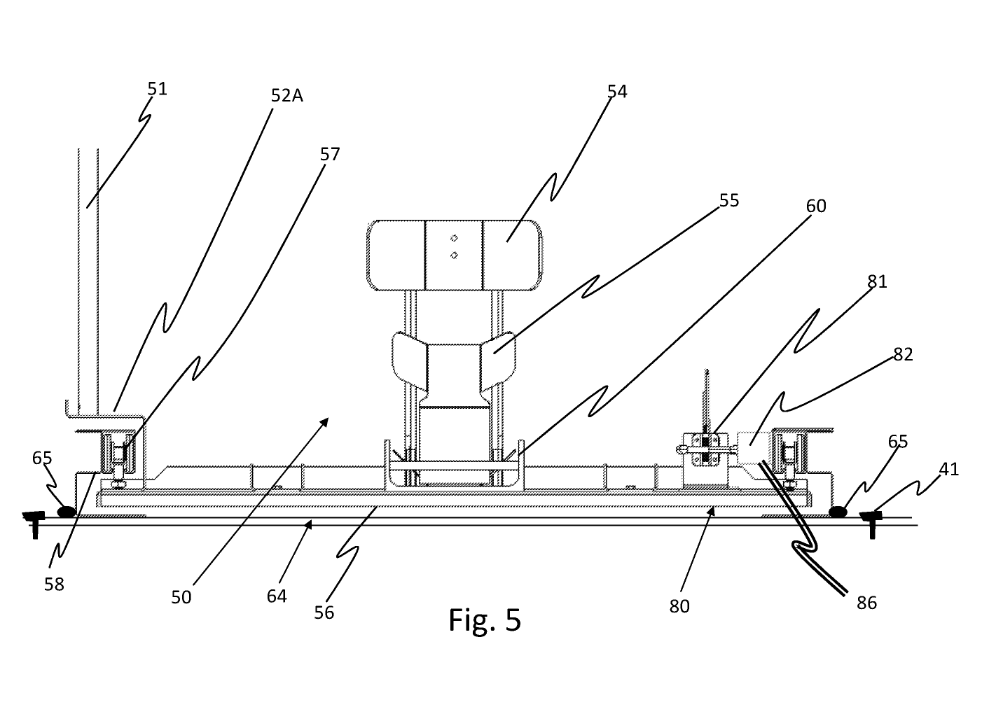

FIG. 5 is a front perspective view of the Special compact motorcycle storage compartment and structural device with features and components shown. Illustrated are the following: a means 41 for securing the storage compartment floor/base frame (optional) 64 to the ground or pavement, such as threaded anchors, tap-cons, barbed stakes and the like; a rigid handle assembly 51; vertical, horizontal, and angled, structure components 52; a handle bracket 52A connecting handle components 52 to platform 56; a wheel chock assembly 50; a handle grip component 53; a front chock wheel stop 54 of chock assembly 50; a rear chock wheel hold component 55 of chock assembly 50; a movable platform or panel 56 for loading a motorcycle 42 or equal into the special compact motorcycle storage compartment and structural device 30; a set of track wheels 57; a pair of track rails 58; a means 59 for securing track wheels 57 to platform assembly 56; a horizontal wheel channel 60 that extends between front wheel stop 54 and rear chock wheel hold component 55 of chock assembly 50; a floor/base frame (optional) 64 of the special compact motorcycle storage compartment and structural device 30; a means 65 for securing (welding, threaded fasteners, rivets, pins, etc.) track to floor/base frame 64 or ground/pavement; an optional automatic drive system 80 with a mechanical drive system (chain, gear, sprocket, belt and pulleys, etc.), driven wheels 81, and motor 82; a mechanically driven 81 and powered wheels; a motor 82 for powered track; ventilation 83 louvers and optional powered ventilation system; and a power source 86 for track motor 82 or trickle charge 84.

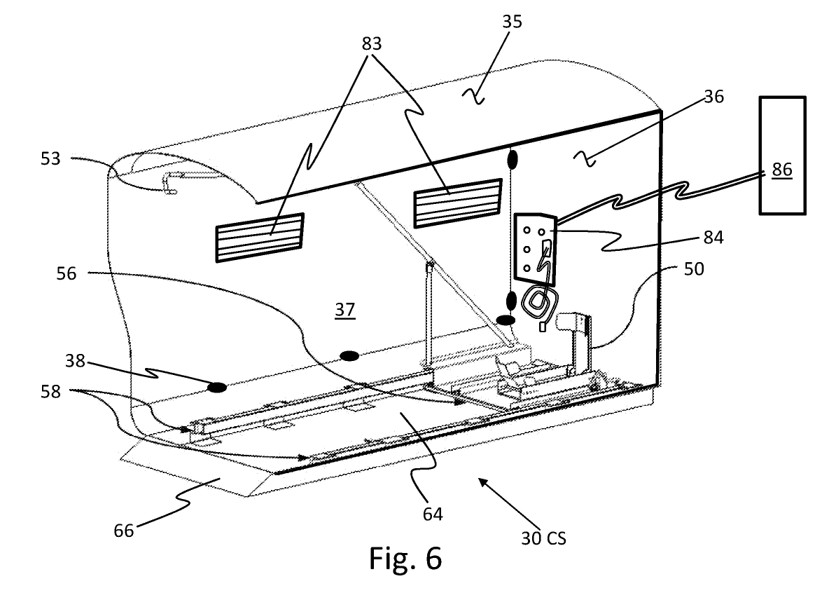

FIG. 6 is a sketch showing a powered and automated loading system and ventilation options for the Special compact motorcycle storage compartment and structural device with components shown. This sketch shows: a cross section view 3005 of the special compact motorcycle storage compartment and structural device 30; a top 35 of the special compact motorcycle storage compartment and structural device 30; an end or rear panel 36 of the special compact motorcycle storage compartment and structural device 30; a pair of side panels 37 of the special compact motorcycle storage compartment and structural device 30; a means 38 for connecting the panels 35, 36, 37, 40, 64 of the compartment 30 such as threaded fasteners, rivets, welding, bent metal tabs, adhesives and the like; a handle grip component 53; a chock assembly 50; a movable platform or panel 56 for loading a motorcycle 42 or equal into the special compact motorcycle storage compartment and structural device 30; a pair of track rails 58; a floor 64 of the special compact motorcycle storage compartment and structural device 30; a means 65 for securing (welding, threaded fasteners, rivets, pins, etc.) track to floor/base frame (optional) 64 or ground/pavement; a ramp 66; optional ventilation 83 louvers and optional powered ventilation system; a trickle charge 84 and optional electric charge station for future electric charging station for electric motor cycles and small vehicles; and a power source 86 for track motor 82 or trickle charge 84. In all these cases of the powered ventilation 83, drive system 80 or charge system 84, it is readily understood and appreciated by one skilled in the art of enclosures which have electrically powered equipment, that electrical connections, conduit, grounding and control systems are required to safely install and use such systems. Local building codes, electricians and engineers can be consulted to readily power and control these relatively simple electrical systems in several ways. If the powered options are present, such connections are needed for the options of this device 30 to be fully enabled. However, these connections and controls are not the unique portion of this invention and can be accomplished in a plethora of ways.

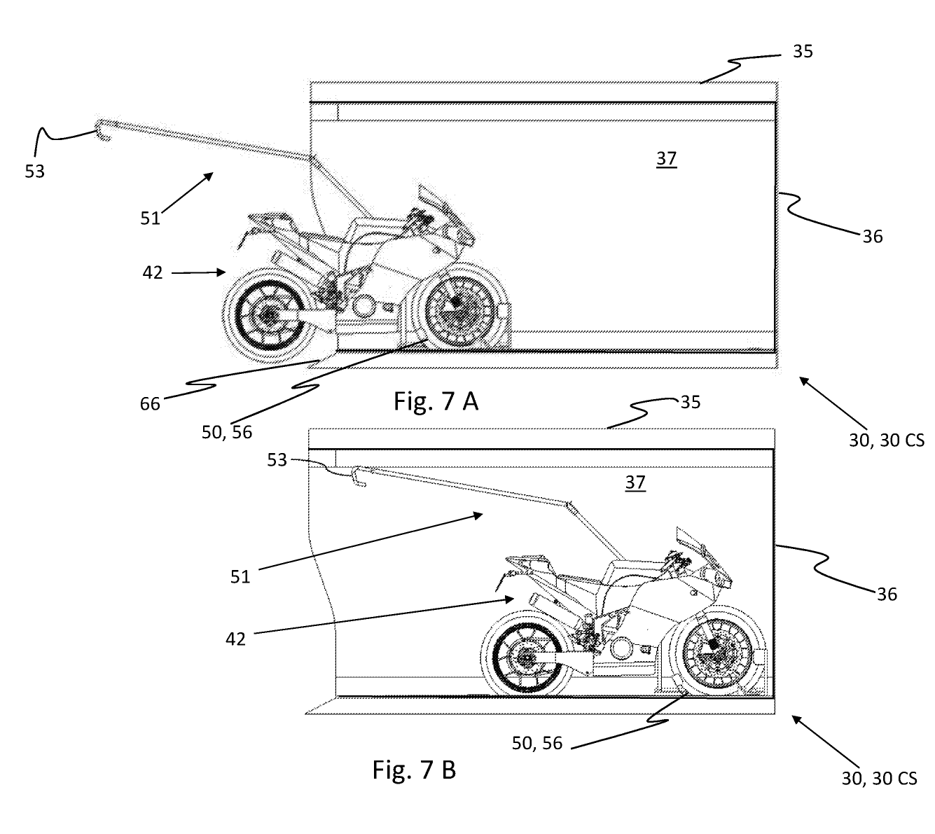

FIGS. 7 A and 7 B are cross sectional side views showing the operation view of the motorcycle 42 just loaded and then pushed into the storage structure 30 and ready to be stored. These are described in the operation section below.

Materials for the special compact motorcycle storage compartment and structural device must be a durable material in order to be secure and withstand vandalism. Also, the panels must withstand the weather—heat, sun, rain, acid rain, hail, snow, wind and the like. The anticipated materials are—for example and not as limitations—selected from sheets of metals: steel, steel alloy, and aluminum; coated sheets such as a steel alloy with a surface finish (paint, plating—galvanized zinc, powder coat, etc.); molded sheets of plastic or a reinforced plastic; and sheets of a composite material either molded, formed or rolled.

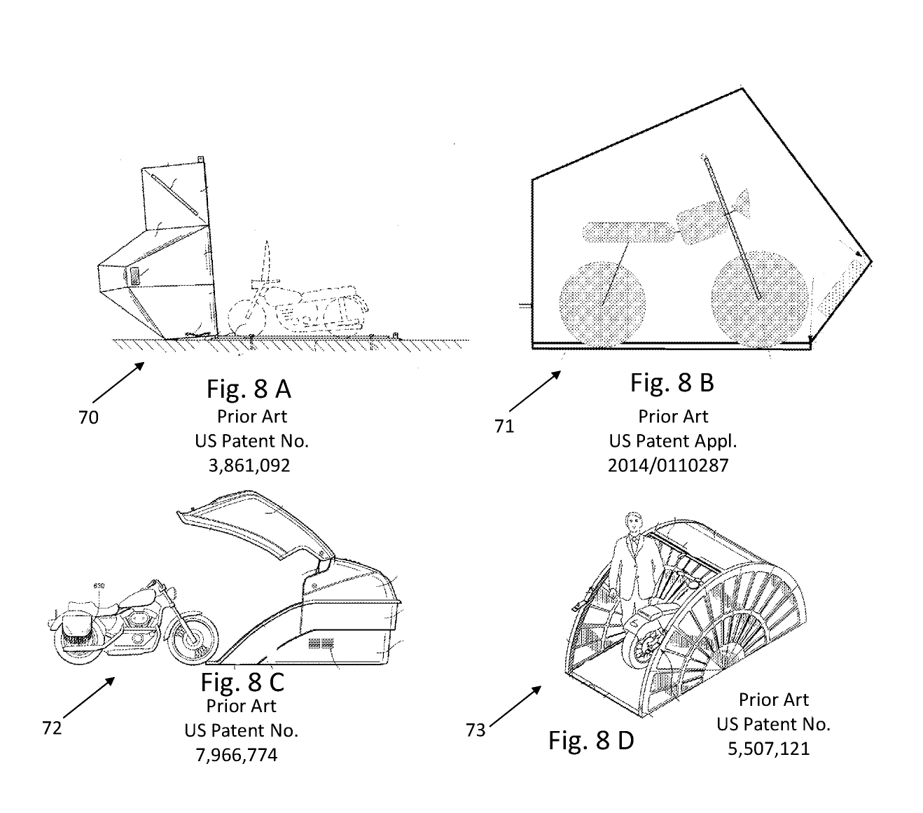

FIG. 8A through 8D are sketches showing enclosures for motorcycles and small vehicles from prior art. Here former patents and applications for various enclosure devices are shown. These include: prior art 70 U.S. Pat. No. 3,861,092 by Dale—a molded storage housing for a motorcycle; prior art 71 Patent Application 2014/0110287 by Hayden—a moveable storage container for storing vehicles; prior art 72 U.S. Pat. No. 7,966,774 by Kea, Jr. et al.—a security shelter for small personal transportation vehicles; and prior Art 73 U.S. Pat. No. 5,507,121 by Taylor—Motorcycle Garage. As can be seen, the special compact motorcycle storage compartment and structural device 30, as described herein, is a unique combination and use from the prior art.

The details mentioned here are exemplary and not limiting. Other specific components and manners specific to describing a Special compact motorcycle storage compartment and structural device 30 may be added as a person having ordinary skill in the field of small vehicle storage structures and devices and their uses.

### Operation of the Preferred Embodiment

The Special compact motorcycle storage compartment and structural device 30 has been described in the above embodiment. The manner of how the device operates is described below. One notes well that the description above and the operation described here must be taken together to fully illustrate the concept of the Special storage device 30. The preferred embodiment of a Special compact motorcycle storage compartment and structural device is comprised of: (a) an enclosure with a floor/base frame (optional) and a lockable front door; (b) a movable platform or panel for loading a motorcycle or small vehicle into the enclosure; (c) a means for securing the enclosure to the ground or pavement; and (d) a means to secure the movable platform to the floor of the enclosure wherein the enclosure can hold a motorcycle inside the enclosure to prevent theft, vandalism, and exposure to weather. An expanded description is a special compact motorcycle storage compartment and structural device comprised of (a) an enclosure with a floor, a lockable front door; a top panel, an end panel opposite the lockable door, a pair of side panels, wherein all of the said panels are made of a durable material and all of the said panels have edges around their respective perimeters, and a means for securing the edges of the panels to form the enclosure; (b) a movable platform or panel for loading a motorcycle or small vehicle into the enclosure, the movable panel further comprised of a track system, a chock assembly, and an optional handle assembly; (c) a means for securing the enclosure to the ground or pavement; and (d) a means to secure the movable platform to the floor/base frame of ground/pavement of the enclosure wherein the enclosure can hold a motorcycle inside the enclosure to prevent theft, vandalism, and exposure to weather.

The Special compact motorcycle storage compartment and structural device 30 is installed as follows: the special compact motorcycle storage compartment and structural device 30 is installed by assembling the roof 35, sides 37 and end 36 together with the floor/base frame (optional) 64 by securely attaching them by the means 38 for connecting the panels 35, 36, 37, 40, 64 of the compartment 30 such as threaded fasteners, rivets, welding, bent metal tabs, adhesives and the like. Next the door 40 with the lock 68 is assembled to the enclosure 30 opposite the end 36 and the ramp 66 attached. If needed, the power from a power source 86 is brought or run to the device 30 and attached to the motor 82 of the optional automatic drive system 80 with a mechanical drive system (chain, gear, sprocket, belt and pulleys, etc.), driven wheels 81 with mechanically driven wheels 81 and motor 82, the optional powered ventilation system or the trickle charge 84 or optional electric charge station for an electric charging station for electric motorcycles and small vehicles. The tracks 58 are secured to the floor/base frame (optional) 64 or the ground/pavement, the wheels 57 are connected to the platform 56, and then the wheeled platform 56, 57 is set onto the tracks 58. Next the handle bracket 52A is attached to the platform 56, the structural components 52 are attached to the bracket 52A, and the handle grip 53 is installed. The chock assembly 50 is assembled (using the means 62) with its parts 54, 55, 60 and set and connected (by means 63) to the platform 56. If desired and appropriate, the ventilation louvers or powered ventilation 83, the motor 82 of the automatic drive system 80 for the track, and the charging station 84 are installed and then connected to the power source 86.

FIGS. 7A and 7B are cross sectional side views showing how the Special compact motorcycle storage compartment and structural device 30 operates. The compartment 30 lock 68 is unlocked and the front door 42 is opened. The grip 53 of the handle system 51 is pulled by the operator/person and pulls the platform 56 to the end of the rails 58 and next to the door 42. The motor cycle 42 is rolled up the ramp 66 and is placed onto the chock assembly 50 and pushed against the front wheel stop 54. The rear lock and hold component 54 is raised and engages the back portion of the front wheel of the motorcycle 42. The rear component 54 is locked with a pin, lever or equal to firmly hold the front wheel of the motorcycle 42. Now the operator/person pushes the motorcycle 42 forward toward the opposite end 36 of the enclosure 30. When the motorcycle 42 is completely in the enclosure, the door 40 is closed and the lock 68 is engaged. Optionally, once the motorcycle 42 is in the wheel chock 50, the trickle charge 84 can be attached, then the motorcycle 42 is pushed into the enclosure 30. Also, if a powered drive 80 is present, after the front wheel of the motorcycle 42 is in the wheel chock 50 and any electrical connections made, the power drive 80 can be started and the motorcycle 42 will automatically be pulled to the end of the enclosure 30. The door 42 is then closed and the lock 68 engaged. To remove the motorcycle, the above steps are simply reversed.

Many uses are anticipated for the Special compact motorcycle storage compartment and structural device 30. Some examples, and not limitations, are the following:

| ITEM | DESCRIPTION |
|---|---|
| 1 | storage at apartment complexes and condominiums |
| 2 | storage for police, homeland security and |
| | military personnel |
| 3 | guest, rentable and/ or secure storage at |
| | hotels and motels |
| 4 | storage in urban parking lots and parking |
| | garages for secure parking |
| 5 | temporary storage lockers for public |
| | locations |
| 6 | pay to park storage structure wherever there |
| | is open space |
| 7 | large package storage or delivery point with |
| | automated locking system |
| 8 | surface space for advertising and marketing |
| 9 | night drop for motorcycle repair/ service |
| | shops |

One notes that all these uses anticipate the lock 68 to have a Bluetooth or equivalent and other lock configurations to be linked with a mobile smartphone application and lock configurations interface with application for Point of Sale/Rental/ authorization by owner of structure.

With this above description it is to be understood that the Special compact motorcycle storage compartment and structural device 30 is not to be limited to only the disclosed embodiment of product. The features of the storage device 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. A special compact motorcycle storage compartment and structural device 30 comprised of:
(a) an enclosure with an optional floor/base frame and a lockable front door 40;
(b) a movable platform or panel 56 for loading a motorcycle 42 or small vehicle into the enclosure;
(c) a means for securing the enclosure to the ground or pavement; and
(d) a means to secure the movable platform to the floor of the enclosure and/or a ground/pavement
wherein the enclosure can hold a motorcycle inside the enclosure to prevent theft, vandalism, and exposure to weather.

2. The special compact motorcycle storage compartment and structural device according to claim 1 wherein the enclosure further comprises a top panel, an end panel opposite the lockable door, a pair of side panels wherein all the said panels have edges around their respective perimeters and a means for securing the edges of the panels to form the enclosure.

3. The special compact motorcycle storage compartment and structural device according to claim 2 wherein the panels are made of a durable material.

4. The special compact motorcycle storage compartment and structural device according to claim 3 wherein the durable material is selected from a group consisting of a metal, a steel, a steel alloy, an aluminum, a steel alloy with a surface finish, a powder coated steel alloy, a plastic, a reinforced plastic, and a composite material.

5. The special compact motorcycle storage compartment and structural device according to claim 1 wherein the movable platform 56 is further comprised of a track system, a chock assembly, and an optional handle assembly.

6. The special compact motorcycle storage compartment and structural device according to claim 5 wherein the track system is comprised of a set of track wheels 57; a pair of track rails 58; and a means 59 for securing track wheels 57 to platform assembly 56.

7. The special compact motorcycle storage compartment and structural device according to claim 5 wherein the chock assembly is comprised of a front chock wheel stop 54 of chock assembly 50; a rear chock wheel hold component 55 of chock assembly 50; a horizontal wheel channel 60 that extends between front wheel stop 54 and rear chock wheel hold component 55 of chock assembly 50; and a means 62 for securing chock components 54, 55, 60 into a chock assembly 50.

8. The special compact motorcycle storage compartment and structural device according to claim 1 wherein the handle assembly 51 for platform 56 is comprised of: a means 51A for securing handle components 52 together to form a rigid handle assembly 51; an optional handle 51, vertical, horizontal, and angled, structural handle components 52; an optional handle bracket 52A connecting handle components 52 to platform 56; an optional handle grip component 53.

9. The special compact motorcycle storage compartment and structural device according to claim 1 wherein the movable platform 56 is further comprised of a track system, a chock assembly, a handle assembly, and a powered drive for the platform.

10. The special compact motorcycle storage compartment and structural device according to claim 1 further comprised of an optional automatic drive system 80 with a set of mechanically driven wheels 81, a motor 82 and a power source 86 for the track motor 82 or trickle charge 84.

11. The special compact motorcycle storage compartment and structural device according to claim 1 further comprised of an optional trickle charge 84 and electric charge station for electrically charging an electric motor cycles and small vehicles and a power source 86 for the trickle charge 84.

12. The special compact motorcycle storage compartment and structural device according to claim 1 further comprised of ventilation 83 louvers and/or a powered ventilation system and power source.

13. A special compact motorcycle storage compartment and structural device 30 comprised of:
(a) an enclosure with an optional floor/base frame 64, a lockable front door 40; a top panel, an end panel opposite the lockable door, a pair of side panels, wherein all of the said panels are made of a durable material and all of the said panels have edges around their respective perimeters, and a means for securing the edges of the panels to form the enclosure;
(b) a movable platform or panel 56 for loading a motorcycle 42 or small vehicle into the enclosure, the movable panel further comprised of a track system, a chock assembly, and a handle assembly;
(c) a means for securing the enclosure to the ground or pavement; and
(d) a means to secure the movable platform to the floor/base frame of the enclosure and/or ground/pavement
wherein the enclosure can hold a motorcycle inside the enclosure to prevent theft, vandalism, and exposure to weather.

14. The special compact motorcycle storage compartment and structural device according to claim 13 wherein the durable material is selected from a group consisting of a metal, a steel, a steel alloy, an aluminum, a steel alloy with a surface finish, a powder coated steel alloy, a plastic, a reinforced plastic, and a composite material.

15. The special compact motorcycle storage compartment and structural device according to claim 13 wherein the track system is comprised of a set of track wheels 57; a pair of track rails 58; and a means 59 for securing track wheels 57 to platform assembly 56.

16. The special compact motorcycle storage compartment and structural device according to claim 13 wherein the chock assembly is comprised of a front chock wheel stop 54 of chock assembly 50; a rear chock wheel hold component 55 of chock assembly 50; a horizontal wheel channel 60 that extends between front wheel stop 54 and rear chock wheel hold component 55 of chock assembly 50; and a means 62 for securing chock components 54, 55, 60 into a chock assembly 50.

17. The special compact motorcycle storage compartment and structural device according to claim 13 wherein the means 62 for securing chock components 54, 55, 60 into a chock assembly 50 is selected from a group consisting of welding, threaded fasteners, rivets, cotter keys and pins, integrally casting and thermoplastic molding.

18. The special compact motorcycle storage compartment and structural device according to claim 13 further comprised of an optional automatic drive system 80 with a set of mechanically driven wheels 81, a motor 82 and a power source 86 for the track motor 82 or trickle charge 84.

19. The special compact motorcycle storage compartment and structural device according to claim 13 further comprised of an optional trickle charge 84 and electric charge station for electrically charging an electric motor cycles and small vehicles and a power source 86 for the trickle charge 84.

20. The special compact motorcycle storage compartment and structural device according to claim 13 further comprised of ventilation 83 louvers and/or a powered ventilation system and power source.
